(19) United States
(12) Patent Application Publication
(10) Pub. No.: US 2013/0045381 A1
(43) Pub. Date: Feb. 21, 2013

(54) MULTILAYER FILM FOR SUPPORTING OPTICAL FUNCTIONAL MEMBER AND METHOD FOR PRODUCING THE SAME, AND PRISM SHEET

(71) Applicants: Tatsuya NOMURA, Kanagawa (JP); Kimi Ikeda, Kanagawa (JP); Hidemasa Hosoda, Kanagawa (JP); Takashi Kobayashi, Kanagawa (JP)

(72) Inventors: Tatsuya NOMURA, Kanagawa (JP); Kimi Ikeda, Kanagawa (JP); Hidemasa Hosoda, Kanagawa (JP); Takashi Kobayashi, Kanagawa (JP)

(21) Appl. No.: 13/561,943

(22) Filed: Jul. 30, 2012

(30) Foreign Application Priority Data
Aug. 19, 2011 (JP) 2011-179658

(51) Int. Cl. B32B 27/36; B05D 5/10; B32B 27/40

(52) U.S. Cl. 428/355 N; 428/423.7; 427/207.1

(57) ABSTRACT

A prism sheet is provided with a prism member, being an optical functional member, and a multilayer film for supporting the prism member. The multilayer film is provided with a base layer and an adhesive layer. One of surfaces of the adhesive layer is adhered to a surface of the base layer. The other surface of the adhesive layer is adhered to the prism member. Thus, the prism member is adhered to the base layer through the adhesive layer. Polyester contained in the adhesive layer has a glass transition temperature Tg of less than 60° C. At least 30 mol % of dicarboxylic acid units in the polyester contained in the adhesive layer have naphthalene rings.

### BACKGROUND OF THE INVENTION

1, Field of the Invention

The present invention relates to a multilayer film, for supporting an optical functional member, provided with an adhesive layer for improving adhesion to the optical functional member, a method for producing the same, and a prism sheet.

2. Description Related to the Prior Art

A display device such as an LCD or a plasma display uses an optical functional sheet made from polymer. Examples of the optical functional sheet include a prism sheet, an anti-reflection sheet, a light diffusion sheet, a hard coat sheet, an IR absorption sheet, an electromagnetic wave shielding sheet, a toning sheet, and an anti-glare sheet. The optical functional sheet is provided with a sheet-like optical functional member and a film for supporting the optical functional member. For example, the prism sheet is provided with a sheet-like prism member and a polyester film for supporting the prism member.

When the sheet-like optical functional member is directly adhered to the polyester film, adhesion between the polyester film and the optical functional member is often insufficient. The adhesion to the optical functional member is improved by using a multilayer film for supporting the optical functional member. The multilayer film is provided with a polyester layer and an adhesive layer formed on the polyester layer. The adhesive layer contains a material with a high adhesive property. For example, in Japanese Patent Laid-Open Publication No. 2000-229395, a multilayer film for supporting the optical functional member is provided with an adhesive layer made from polyester resin (hereinafter simply referred to as polyester) and polyurethane resin (hereinafter simply referred to as polyurethane) to improve the adhesive property. In U.S. Patent Application Publication No. 2011/0045288 (corresponding to Japanese Patent Laid-Open Publication No. 2009-220376), a multilayer film for supporting the functional member is provided with an adhesive layer containing polyurethane having a polycarbonate structure to improve the adhesion to solvent-free UV curable resin.

When the multilayer film for supporting the optical functional member is exposed to high temperature and high humidity for a long time during storage or transportation, oligomer from the polyester layer bleeds out to the surface of the adhesive layer. This causes problems in optical properties and appearance of the multilayer film. To prevent the bleeding out of the oligomer, the temperature and humidity may be adjusted throughout the storage and transportation. This, however, increases cost and is not practical.

In Japanese Patent Laid-Open Publication No. 2007-253512, the adhesive layer is formed of polyester having a glass transition temperature Tg in the range of 105° C. to 135° C. that achieves a high refractive index and polyester having a glass transition temperature Tg in the range of 65° C. to 95° C. that improves the adhesive property and prevents the bleeding out of the oligomer.

However, the adhesive layers disclosed in the Japanese Patent Laid-Open Publication No. 2000-229395, the U.S. Patent Application Publication No. 2011/0045288, and the Japanese Patent Laid-Open Publication No. 2007-253512 may not achieve the required adhesive property depending on a material for the optical functional member. When the material for the optical functional member is the solvent-free UV curable resin, dissolution and swelling of the adhesive layer does not occur because there is no solvent. Accordingly, permeation of the UV curable resin into the adhesive layer or interface mixing hardly occurs. Thus, the adhesive layer disclosed in the Japanese Patent Laid-Open Publication No. 2000-229395 does not have the adhesive property required for the adhesion to the solvent-free UV curable resin.

Recently, bisphenol A diacrylate resin (see general formula (1)) has been used as the solvent-free UV curable resin to improve scratch resistance of the optical functional member. The bisphenol A diacrylate resin has a relatively long polyethylene oxide chain. Namely, an average added mol number (n+m) is at least 5.

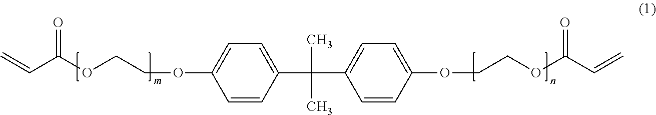

The molecular weight of a compound expressed by the general formula (1) is greater than that of a conventional compound (for example, a compound expressed by the general formula (1) with the average added mol number (n+m) of 2 to 4). This makes the permeation of the compound with the average added mol number (n+m) of 5 or more into the adhesive layer extremely difficult. As a result, the adhesive layers disclosed in the Japanese Patent Laid-Open Publication No. 2000-229395, the U.S. Patent Application Publication No. 2011/0045288, and the Japanese Patent Laid-Open Publication No. 2007-253512 have insufficient adhesive properties. Additionally, none of the Japanese Patent Laid-Open Publication No. 2000-229395 and the U.S. Patent Application Publication No. 2011/0045288 provides a solution to prevent the bleeding out of the oligomer.

### SUMMARY OF THE INVENTION

An object of the present invention is to provide a multilayer film, for supporting an optical functional member, with a good adhesive property to solvent-free UV curable resin and a method for producing the same.

Another object of the present invention is to provide a multilayer film, for supporting an optical functional member, that prevents bleeding out of oligomer under high temperature or under high temperature and high humidity, and a method for producing the same.

Still another object of the present invention is to provide a prism sheet having a multilayer film for supporting an optical functional member and the optical functional member adhered to the multilayer film.

The multilayer film for supporting an optical functional member of the present invention includes a polyester layer and an adhesive layer to be adhered to the optical functional member. The adhesive layer is provided on at least one of surfaces of the polyester layer. The adhesive layer contains polyester for the adhesive layer, polyurethane, and a cross-linking agent. A glass transition temperature Tg of the polyester for the adhesive layer is less than 60° C. At least 30 mol % of dicarboxylic acid units in the polyester for the adhesive layer have naphthalene rings.

It is preferable that the adhesive layer has a base adhesion sublayer provided on the polyester layer and a member adhesion sublayer provided on the base adhesion sublayer. The base adhesion sublayer contains polyester for the base adhesion sublayer. It is preferable that at least 30 mol % of dicarboxylic acid units in the polyester for the base adhesion sublayer have naphthalene rings. It is preferable that the member adhesion sublayer contains the polyester for the adhesive layer, the polyurethane, and the cross-linking agent. The member adhesion sublayer has an adhesive surface to be adhered to the optical functional member. It is preferable that mass concentration of the polyester for the base adhesion sublayer is higher than mass concentration of the polyester for the adhesive layer contained in the member adhesion sublayer.

It is preferable that a glass transition temperature Tg of the polyester for the base adhesion sublayer is higher than a storage temperature of the multilayer film. It is preferable that the glass transition temperature Tg of the polyester for the base adhesion sublayer is higher than the glass transition temperature Tg of the polyester for the adhesive layer contained in the member adhesion sublayer.

It is preferable that the thickness of the adhesive layer is in a range of at least 0.5 μm and at most 2.5 μm.

A prism sheet includes a polyester layer, an adhesive layer, and a prism member. The adhesive layer is provided on at least one of surfaces of the polyester layer. The adhesive layer contains polyester, polyurethane, and a cross-linking agent. A glass transition temperature Tg of the polyester is less than 60° C. At least 30 mol % of dicarboxylic acid units in the polyester have naphthalene rings. The prism member is adhered to the adhesive layer and made from solvent-free UV-cured acrylic resin. The prism member is an optical functional member. The optical functional member is supported by a multilayer film. The multilayer film includes the polyester layer and the adhesive layer.

It is preferable that at least 40 mass % of the solvent-free UV-cured acrylic resin is composed of resin components each expressed by a general formula (1) and having an average added mol number (n+m), of polyethylene oxide chain, of at least 5.

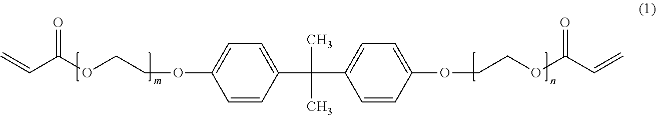

A method for producing a multilayer film for supporting an optical functional member includes an applying step and a forming step. In the applying step, an adhesive layer coating liquid is applied over the polyester layer to form a coating layer covering the polyester layer. The adhesive layer coating liquid contains polyester for an adhesive layer, polyurethane, a cross-linking agent, and a solvent. The polyester for the adhesive layer has a glass transition temperature Tg of less than 60° C. At least 30 mol % of dicarboxylic acid units in the polyester for the adhesive layer have naphthalene rings. In the forming step, the solvent is evaporated from the coating layer to form an adhesive layer to be adhered to the optical functional member.

It is preferable that the method further includes an applying step and a forming step for a base adhesion sublayer. In the applying step for the base adhesion sublayer, a base adhesion sublayer coating liquid is applied on the polyester layer to form a base adhesion sublayer coating layer on the polyester layer. The base adhesion sublayer coating liquid contains polyester for the base adhesion sublayer, a cross-linking agent, and a solvent. At least 30 mol % of dicarboxylic acid units in the polyester for the base adhesion sublayer have naphthalene rings. In the forming step for the base adhesion sublayer, the solvent is evaporated from the base adhesion sublayer coating layer to form the base adhesion sublayer. It is preferable that mass concentration of the polyester for the base adhesion sublayer in a solid content of the base adhesion sublayer coating liquid is higher than mass concentration of the polyester for the adhesive layer in a solid content of the adhesive layer coating liquid. The adhesive layer coating liquid is applied on the base adhesion sublayer.

According to the present invention, the multilayer film has the good adhesive property to the solvent-free UV curable resin, and the bleeding out of the oligomer at high temperature or at high temperature and high humidity is prevented.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic cross-sectional view of a first optical functional member;

FIG. 2 is a schematic cross-sectional view of a second optical functional member;

FIG. 3 is a schematic cross-sectional view of a third optical functional member; and

FIG. 4 is a schematic side view of a display device.

### DESCRIPTION OF THE PREFERRED EMBODIMENTS

(Prism Sheet)

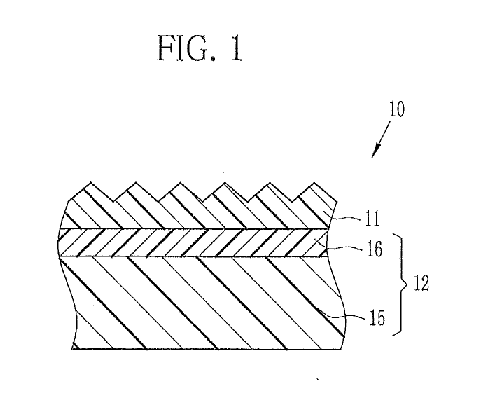

As shown in FIG. 1, a prism sheet 10 is provided with a prism member 11, being an optical functional member, and a multilayer film 12 for supporting the prism member 11. The multilayer film 12 is provided with a base layer (polyester layer) 15 and an adhesive layer 16. One of surfaces of the adhesive layer 16 is adhered to or placed over the base layer 15 to cover the base layer 15. The other surface of the adhesive layer 16 is adhered to the prism member 11. Thus, the adhesive layer 16 ensures adhesion between the prism member 11 and the base layer 15. The adhesive layer 16 may partly cover the base layer 15.

(Prism Member)

The prism member 11 made from solvent-free UV-cured acrylic resin transmits light, and has a prism pattern on its surface. The prism member 11 improves front brightness of a backlight unit provided in an LCD, for example. The prism member 11 contains the solvent-free UV-cured acrylic resin at mass concentration of at least 90%. At least 40 mass %, more preferably, at least 50 mass % of the solvent-free UV-cured acrylic resin is composed of resin component(s) each expressed by a general formula (1) and having an average added mol number (n+m), of polyethylene oxide chain, of at least 5. It is preferable that the average added mol number (n+m) is less than or equal to 20. When the average added mol number exceeds 20, the brightness decreases due to decrease in refractive index. Note that the average added mol number is preferably in the range of 6 to 16.

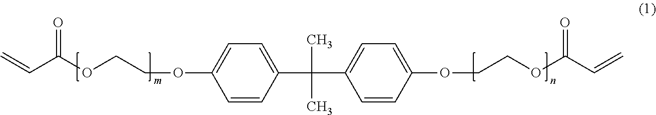

(Base Layer)

The base layer 15 is made from polyester resin (hereinafter simply referred to as polyester), for example, polyethylene terephthalate, polyethylene naphthalate, polybutylene terephthalate, or polybutylene naphthalate. Of those, the polyethylene terephthalate is especially preferable in view of cost and mechanical strength.

It is preferable that the base layer 15 is subjected to stretching so as to improve its mechanical strength. The base layer 15 subjected to biaxial stretching is especially preferable. A stretch or draw ratio is not particularly limited, but the stretch ratio of 1.5 to 7 times is preferable. The stretch ratio of 2 to 5 times is more preferable. A film stretched biaxially at the stretch ratio of 2 to 5 times in each of two directions orthogonal to each other in the film surface is especially preferable. When the stretch ratio is less than 1.5 times, sufficient mechanical strength cannot be achieved. On the other hand, when the stretch ratio exceeds 7 times, it becomes difficult to keep the film thickness uniform.

The thickness of the base layer 15 is, for example, at least 30 μm and at most 500 μm, and more preferably, 50 μm or more and 300 μm or less. It is not preferable when the thickness of the base layer 15 is less than 30 μm, because the base layer 15 becomes too soft to handle. On the other hand, the base layer 15 with the thickness exceeding 500 μm hinders downsizing and weight reduction of the display device, resulting in cost increase.

(Adhesive Layer)

The adhesive layer 16 contains polyester, polyurethane resin (hereinafter simply referred to as polyurethane), and a cross-linking agent. Note that an additive may be added to the adhesive layer 16 when necessary. The thickness of the adhesive layer 16 is, for example, at least 0.5 μm and at most 2.5 μm, and preferably, 0.6 μm or more and 2.0 μm or less.

(Polyester)

It is preferable that glass transition temperature Tg of the polyester contained in the adhesive layer 16 is less than 60° C. It is more preferable that all the polyester contained in the adhesive layer 16 has the glass transition temperature Tg of less than 60° C. The polyester contained in the adhesive layer 16 is copolymerized polyester having naphthalene rings. The copolymerized polyester ensures the adhesion between the adhesive layer 16 and the biaxially stretched base layer 15. The glass transition temperature Tg of the copolymerized polyester contained in the adhesive layer 16 is less than 60° C., which ensures the adhesion between the adhesive layer 16 and the solvent-free UV-cured acrylic resin expressed by the general formula (1). In view of adhesive property, the glass transition temperature Tg of the copolymerized polyester contained in the adhesive layer 16 is preferably 50° C. or less.

The copolymerized polyester contained in the adhesive layer 16 may be a mixture of two or more types of polyester. In this case, it is preferable that the mixture contains the polyester having the glass transition temperature Tg of less than 60° C. The polyester having the glass transition temperature Tg of 60° C. or more may be added to the mixture. However, this makes permeation of the solvent free UV-cured acrylic resin, expressed by the general formula (1), into the adhesive layer 16 difficult, resulting in adhesion deficiency. To avoid this, the concentration of the polyester having the glass transition temperature Tg of 60° C. or more in the copolymerized polyester in the adhesive layer 16 is preferably at most 10 mass %, more preferably, 5 mass %. In other words, the concentration of the polyester having the glass transition temperature Tg of less than 60° C. in the copolymerized polyester in the adhesive layer 16 is preferably at least 90 mass %, more preferably, 95 mass %.

Using the compound having the naphthalene rings as the copolymerized polyester in the adhesive layer 16 prevents bleeding out of the oligomer on the surface of the adhesive layer 16. It is considered that high compatibility between an oligomer component of the base layer 15 and the copolymerized polyester having the naphthalene rings prevents the bleeding out of the oligomer.

Note that the polyester having the glass transition temperature Tg of less than −20° C. is unstable and therefore not suitable for the adhesive layer 16. So, the glass transition temperature Tg of the polyester contained in the adhesive layer 16 is preferably at least −20° C. To be more specific, the glass transition temperature Tg of the polyester is preferably at least −20° C. and less than 60° C., and more preferably −10° C. or more and 50° C. or less.

A method for measuring the glass transition temperature Tg is described in JIS K 7121 (1987) corresponding to ISO 3146.

The glass transition temperature Tg of the copolymerized polyester having the naphthalene rings tends to be higher than that of the copolymerized polyester with no naphthalene ring. Accordingly, the copolymerized polyester having the naphthalene rings and the glass transition temperature Tg of less than 60° C. is preferably the copolymerized polyester having dicarboxylic acid units and diol units described below.

(Dicarboxylic Acid)

It is preferable that the copolymerized polyester contains a 2,6-naphthalenedicarboxylic acid unit as the dicarboxylic acid unit. The copolymerized polyester having the naphthalene rings and the glass transition temperature Tg of less than 60° C. may have a dicarboxylic acid unit expressed by a chemical formula (1), a terephthalic acid unit, or an isophthalic acid unit as the dicarboxylic acid unit.

HOOC—(CH₂)ₙ—COOH (“n” denotes a natural number satisfying 4≦n≦10) (1)

It is preferable that a mole percentage “X” (unit: mol %) of 2,6-naphthalenedicarboxylic acid units to the total dicarboxylic acid units in the copolymerized polyester having the naphthalene rings is at least 30 mol % and at most 90 mol %. When the X is less than 30 mol %, the bleeding out of the oligomer cannot be prevented sufficiently. When the X is greater than 90 mol %, the glass transition temperature Tg of the copolymerized polyester increases. This weakens the adhesion between the adhesive layer 16 and the solvent-free UV-cured acrylic resin, which is not preferable. The X is more preferably 40 mol % or more and 80 mol % or less, and furthermore preferably 50 mol % or more and 75 mol % or less. Note that the mole percentage X is obtained by an expression X=the number of moles of 2, 6-naphthalenedicarboxylic acid units/the total number of moles of the dicarboxylic acid units in the copolymerized polyester having the naphthalene rings×100.

To produce the copolymerized polyester having the mole percentage X in the above-described range, it is preferable to make a mole percentage of the dicarboxylic acid units having the naphthalene rings to the total dicarboxylic acid units for producing the copolymerized polyester the same as the mole percentage X. Namely, the mole percentage of the dicarboxylic acid having the naphthalene rings is preferably at least 30 mol % and at most 90 mol %. The mole percentage of the dicarboxylic acid units having the naphthalene rings to the total dicarboxylic acid units for producing the copolymerized polyester is more preferably 40 mol % or more and 80 mol % or less, and furthermore preferably 50 mol % or more and 75 mol % or less.

(Diol)

The copolymerized polyester preferably contains a diol unit that lowers the glass transition temperature Tg of the copolymerized polyester. Examples of the diol unit include a diol unit expressed by a chemical formula (2), an ethylene glycol unit, a diethylene glycol unit, and a triethylene glycol unit.

HO—(CH₂)ₘ—OH (“m” denotes a natural number satisfying 4≦m≦10) (2)

A mole percentage Y of the diol units expressed by the chemical formula (2) to the total diol units in the copolymerized polyester is preferably at least 10 mol % and at most 95 mol %, and more preferably 20 mol % or more and 90 mol % or less, and furthermore preferably 30 mol % or more and 85 mol % or less. When the mole percentage Y is less than 10 mol %, the diol units cannot lower the glass transition temperature Tg sufficiently. As a result, the adhesion between the adhesive layer 16 and the solvent-free UV-cured acrylic resin decreases. When the mole percentage Y exceeds 95 mol %, on the other hand, a rate of polymerization may be lowered.

To produce the copolymerized polyester with the mole percentage Y of the diol units in the above-described range, a mole percentage of the diol units, expressed by the chemical formula (2), to the total diol units for producing the copolymerized polyester is preferably at least 10 mol % and at most 95 mol %, and more preferably 20 mol % or more and 90 mol % or less, and furthermore preferably 30 mol % or more and 85 mol % or less, in the same manner as the mole percentage Y.

For example, Plas-Coat Z592 available from Goo Chemical Co., Ltd. can be used as the polyester in the present invention.

(Polyurethane)

The polyurethane contained in the adhesive layer 16 ensures the adhesion between the adhesive layer 16 and the prism member 11. The term “polyurethane” is a generic name for polymer having urethane bonds in a main chain, and normally synthesized by a reaction between polyisocyanate and polyol. Examples of polyisocyanate include TDI (toluene diisocyanate), MDI (methylene diphenyl diisocyanate), NDI (naphthalene diisocyanate), TODI (tolidine diisocyanate), HDI (hexamethylene diisocyanate) and IPDI (isophorone diisocyanate). Examples of polyol include ethylene glycol, propylene glycol, glycerin, and hexanetriol. In the present invention, isocyanate can be polymer with molecular weight increased by chain-extension process of polyurethane polymer synthesized by the reaction between polyisocyanate and polyol. The isocyanate, the polyol and the chain-extension process are described in “Polyurethane handbook” (edited by Keiji IWATA, published by Nikkan Kogyo Shinbunsha, 1987), for example. Note that the adhesive layer 16 may contain one or more types of polyurethane.

The polyurethane contained in the adhesive layer 16 preferably has the glass transition temperature Tg of at least −40° C. and at most 50° C., more preferably, −20° C. or more and 40° C. or less. When the glass transition temperature Tg of the polyurethane in the adhesive layer 16 exceeds 50° C., the permeation of the solvent free UV-cured acrylic resin, expressed by the general formula (1), into the adhesive layer 16 becomes difficult, resulting in adhesion deficiency. When the glass transition temperature Tg of the polyurethane in the adhesive layer 16 is less than −40° C., the polyurethane becomes unstable, which is not preferable.

For example, SUPERFLEX 150HS or SUPERFLEX 470 available from DAI-ICHI KOGYO SEIYAKU CO., LTD., HYDRAN AP-20, HYDRAN WLS-210, or HYDRAN HW-161 available from DIC Corporation may be used as the polyurethane of the present invention.

(Cross-Linking Agent)

Examples of the cross-linking agent used in the present invention include isocyanate compounds, oxazoline compounds, carbodiimide compounds, melamine compounds, urea compounds, and epoxy compounds. Of these, the oxazoline compounds and the carbodiimide compounds are preferable in view of temporal stability of a coating liquid and the adhesive property after high temperature and high humidity treatment. The cross-linking agents may be used singly or in combination.

Examples of the oxazoline compounds having an oxazoline group include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, and 2-isopropenyl-5-methyl-2-oxazoline. The oxazoline compounds may be used singly or in combination. For example, EPOCROS K2020E, EPOCROS K-2010E, EPOCROS K-2030E, EPOCROS WS-300, EPOCROS WS-500, or EPOCROS WS-700 available from NIPPON SHOKUBAI CO., LTD. can be used.

It is preferable to add the oxazoline compound in the range of 5 mass % to 50 mass %, more preferably, 10 mass % to 40 mass % relative to a binder. By adding the oxazoline compound in the above range, the high adhesion to the base layer 15 is maintained after the high temperature and high humidity treatment. On the other hand, when the amount of the oxazoline compound added is less than 5 mass %, the adhesion becomes defective with time under high temperature and high humidity conditions. When the amount of the oxazoline compound added exceeds 50 mass %, the stability of the coating liquid deteriorates. The term “binder” includes both the polyester and polyurethane.

Any compound having two or more carbodiimide groups in a molecule can be used as the cross-linking agent. Generally, polycarbodiimide is synthesized by condensation reaction of organic diisocyanate. An organic group of the organic diisocyanate is not particularly limited. One of aromatic compounds, and aliphatic compounds, or a mixture of them may be used. In view of reactivity, the aliphatic compounds are particularly preferable. For synthetic raw materials, the organic isocyanate, the organic diisocyanate, the organic triisocyanate, or the like is used.

Examples of the organic isocyanate include aromatic isocyanate, aliphatic isocyanate, and a mixture of them. To be more specific, 4,4′-diphenyl methane diisocyanate, 4,4-diphenyl dimethyl methane diisocyanate, 1,4-phenylene diisocyanate, 2,4-tolylene diisocyanate, 2,6-tolylene diisocyanate, hexamethylene diisocyanate, cyclohexane diisocyanate, xylylene diisocyanate, 2,2,4-trimethyl hexamethylene diisocyanate, 4,4′-dicyclohexyl methane diisocyanate, 1,3-phenylene diisocyanate, or the like is used. For organic monoisocyanate, isophorone isocyanate, phenyl isocyanate, cyclohexyl isocyanate, butyl isocyanate, naphthyl isocyanate, or the like may be used. Examples of the carbodiimide compound includes CARBODILITE V-02-L2, CARBODILITE V-02, CARBODILITE V-04, CARBODILITE V-06, CARBODILITE E-01, CARBODILITE E-02, CARBODILITE E-03A, and CARBODILITE E-04 available from Nisshinbo Chemical Inc.

It is preferable to add the carbodiimide compound(s) of the present invention in the range of 15 mass % to 80 mass % relative to the amount of the binder, more preferably, 20 mass % to 75 mass %. By adding the carbodiimide compound(s) in the above range, the adhesion between the adhesive layer 16 and the base layer 15 improves. On the other hand, when the addition is less than 15 mass %, the adhesion to the base layer 15 deteriorates. When the addition exceeds 80 mass %, too much cost is incurred.

(Additive Agent)

A matting agent, a surface active agent, a lubricant, a preservative, or the like may be used as an additive agent.

Organic or inorganic fine particles may be used as the matting agent. For example, polymer fine particles such as polystyrene, polymethyl methacrylate, silicone resin, or benzoguanamine resin, or inorganic fine particles such as silica, calcium carbonate, magnesium oxide, or magnesium carbonate may be used. Of these, in view of lubrication improvement and cost, polystyrene, polymethyl methacrylate, and silica are preferable.

Average particle diameter of the matting agent is preferably in the range of 0.01 μm to 12 μm, more preferably 0.03 μm to 9 μm. Thereby, the lubrication of the adhesive layer 16 improves sufficiently without causing degradation in display quality of a display device. Two or more matting agents with different average particle diameters may be used in combination.

Although depending partly on the average particle diameter, the amount of the matting agent is preferably in the range of 0.1 mg/m² to 100 mg/m², more preferably in the range of 0.5 mg/m² to 50 mg/m². Thereby, the lubrication of the adhesive layer 16 improves sufficiently without causing degradation in the display quality of the display device.

The surface active agent may be of a known anionic type, a known nonionic type, or a known cationic type. The surface active agents are described in, for example, “Handbook of Surface Active Agent” (edited by Ichiro Nishi, Ichiro Imai, and Masatake Kasai, Published by Sangyo Tosho Publishers, Inc., 1960). The amount of the surface active agent is preferably in the range of 0.1 mg/m² to 30 mg/m², or more preferably in the range of 0.2 mg/m² to 10 mg/m². Thereby, the surface of the adhesive layer 16 is maintained in good condition without repelling.

Examples of lubricating agent include synthesized and natural wax, silicone compounds, R—O—SO₃M (“R” denotes substituted or non-substituted alkyl group. The number of carbons is from 3 to 20. “M” denotes a monovalent metal atom).

To be more specific, the examples of the lubricating agent include wax such as SEROZOL 524, 428, 732-B, 920, B-495, HYDRIN P-7, D-757, Z-7-30, E-366, F-115, D-336, D-337, POLYRON A, 393, H-481, HIMICRON G-110F, 930, G-270 (available from Chukyo Yushi Co., Ltd.), CHEMIPEARL W100, W200, W300, W400, W500, and W950 (available from Mitsui Chemicals Inc.), silicones such as KF-412, 413, 414, 393, 859, 8002, 6001, 6002, 857, 410, 910, 851, X-22-162A, X-22-161A, X-22-162C, X-22-160AS, X-22-164B, X-22-164C, X-22-170B, X-22-800, X-22-819, X-22-820, and X-22-821, (available from Shin-Etsu Chemical Co., Ltd.), and compounds such as C₁₆H₃₃—O—SO₃Na and C₁₈H₃₇—O—SO₃Na expressed by the above-described general formula. It is preferable to add the lubricating agent in the range of 0.1 mg/m² to 50 mg/m², more preferably, in the range of 1 mg/m² to 20 mg/m². Thereby, sufficient lubrication property is obtained while the surface of the adhesive layer 16 is maintained in good condition.

(Method for Producing Multilayer Film)

The base layer 15 is produced by extruding melted polymer. Next, the base layer 15 is drawn or stretched biaxially. It is preferable that the directions of the stretching are orthogonal to each other. Then, a coating liquid (adhesive layer coating liquid), being a raw material of the adhesive layer 16, is applied on or over one of surfaces of the biaxially-stretched base layer 15 to form a coating layer on or over the base layer 15. The coating liquid contains the polyester, the polyurethane, and the cross-linking agent dissolved in a solvent. The polyester contained in the coating liquid has the glass transition temperature Tg of less than 60° C., and at least 30 mol % of the dicarboxylic acid units in the polyester have naphthalene rings. The solvent is evaporated from the coating layer. Thereby, the adhesive layer 16 is formed on or over the base layer 15. The adhesive layer 16 and the base layer 15 constitutes the multilayer film 12.

A method for applying the coating liquid is not particularly limited. For example, a known method such as a bar coating method or a slide coating method may be used. The solvent may be a water solvent or an organic solvent, or a mixture of them, for example, water, toluene, methyl alcohol, isopropyl alcohol, or methyl ethyl ketone. Of these, it is preferable to use water as the solvent in view of cost and easy production.

The coating liquid for producing the adhesive layer 16 is applied on or over the biaxially-stretched base layer 15. Thereby, the multilayer film 12 has uniform optical properties and good surface condition.

(Method for Producing Prism Sheet)

UV curable resin for producing the prism member 11 is applied on the surface of the adhesive layer 16 of the multilayer film 12 to form a coating film. Next, the ultraviolet rays are applied to the surface of the coating film while a mold for forming the prism sheet is pressed against the surface of the coating film. Thereby, the coating film is cured and thus the prism sheet 10 provided with the multilayer film 12 and the prism member 11 is obtained.

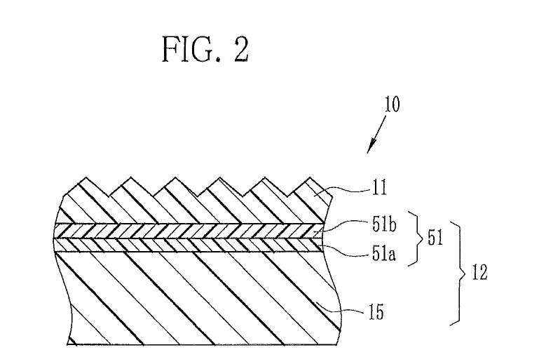

Note that as shown in FIG. 2, an adhesive layer 51 having two or more layers may be provided instead of the adhesive layer 16, being the single layer. The adhesive layer 51 is provided with a base adhesion sublayer 51a and a member adhesion sublayer 51b. The base adhesion sublayer 51a is adhered to the base layer 15. The member adhesion sublayer 51b is provided on the base adhesion sublayer 51a such that one of surfaces of the member adhesion sublayer 51b is adhered to the base adhesion sublayer 51a. Thus, the member adhesion sublayer 51b is adhered to the base layer 15 through the base adhesion sublayer 51a. The other surface, being an adhesive surface, of the member adhesion sublayer 51b is to be adhered to the prism member 11. Thereby, the prism member 11 is adhered to the base layer 15 through the adhesive layer 51 composed of the member adhesion sublayer 51b and the base adhesion sublayer 51a.

The base adhesion sublayer 51a contains the polyester and a cross-linking agent. Note that the base adhesion sublayer 51a may contain the polyester and the polyurethane. The member adhesion sublayer 51b contains the polyester, the polyurethane, and the cross-linking agent.

A condition (A1) is required to prevent the bleeding out of the oligomer. It is preferable to satisfy the condition (2) to further prevent the bleeding out of the oligomer.

(A1) Each of the polyester contained in the base adhesion sublayer 51a and the polyester contained in the member adhesion sublayer 51b has the naphthalene rings.

(A2) The glass transition temperature Tg of the polyester contained in the base adhesion sublayer 51a is high.

As for the condition (A1), each of the mole percentage X of the dicarboxylic acid units having the naphthalene rings to the dicarboxylic acid units in the base adhesion sublayer 51a and in the member adhesion sublayer 51b is preferably at least 30 mol % and at most 90 mol %. As for the condition (A2), it is preferable that the glass transition temperature Tg of the polyester contained in the base adhesion sublayer 51a is higher than a storage temperature or a temperature of an environmental test of the multilayer film 12 and the prism sheet 10. Furthermore, it is preferable that the glass transition temperature Tg of the polyester contained in the base adhesion sublayer 51a is higher than the glass transition temperature Tg of the polyester contained in the member adhesion sublayer 51b. The glass transition temperature Tg of the polyester contained in the base adhesion sublayer 51a may be 70° C. or more, for example.

The condition (A2) surely prevents the bleeding out of the oligomer as follows. When the glass transition temperature Tg of the polyester is high, vibration of polyester molecules is suppressed. Thereby, the oligomer from the base layer 15 cannot permeate the base adhesion sublayer 51a. Thus, the bleeding out of the oligomer from the base layer 15 is prevented.

To improve the adhesion of the member adhesion sublayer 51b to the prism member 11, a condition (B1) is required. Furthermore, to improve the adhesion of the base adhesion sublayer 51a to the base layer 15, it is preferable to satisfy a condition (B2).

(B1) The glass transition temperature Tg of the polyester contained in the member adhesion sublayer 51b is less than 60° C.

(B2) The mass concentration of the polyester contained in the base adhesion sublayer 51a is higher than that of polyester contained in the member adhesion sublayer 51b.

The polyester and the polyurethane contained in each of the base adhesion sublayer 51a and the member adhesion sublayer 51b may be the same as those contained in the adhesive layer 16.

The method for producing the multilayer film 12 shown in FIG. 2 has an applying step for the base adhesion sublayer 51a, a forming step for the base adhesion sublayer 51a, an applying step for the member adhesion sublayer 51b, and a forming step for the member adhesion sublayer 51b. In the applying step for the base adhesion sublayer 51a, a coating liquid (base adhesion sublayer coating liquid) for the base adhesion sublayer 51a is applied on the base layer 15 to form a coating layer (base adhesion sublayer coating layer). The base adhesion sublayer coating liquid contains the polyester, the cross-linking agent, and the solvent. At least 30 mol % of the dicarboxylic acid units in the polyester in the base adhesion sublayer coating liquid have naphthalene rings. In the forming step for the base adhesion sublayer 51a, the solvent is evaporated from the base adhesion sublayer coating layer or the base adhesion sublayer coating liquid applied. Thereby, the base adhesion sublayer 51a is formed. In the applying step for the member adhesion sublayer 51b, a coating liquid (adhesive layer coating liquid) for the member adhesion sublayer 51b is applied on the base adhesion sublayer 51a to form a coating layer. In the forming step for the member adhesion sublayer 51b, the solvent is evaporated from the coating layer or the coating liquid applied. Thereby, the member adhesion sublayer 51b is formed. The mass concentration of the polyester in a solid content in the base adhesion sublayer coating liquid is higher than that in the coating liquid for the member adhesion sublayer 51b. The base adhesion sublayer 51a and/or the member adhesion sublayer 51b may partly cover the base layer 15.

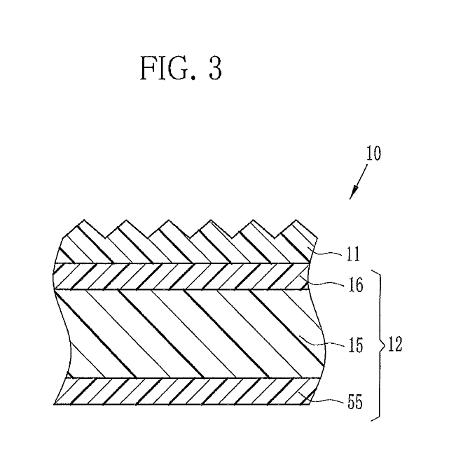

Note that an adhesive layer 55 may be provided additionally on or over a surface of the base layer 15 opposite to the adhesive layer 16 as shown in FIG. 3. The adhesive layer 55 provided on the surface opposite to the prism member 11 enhances adhesion to another optical functional member.

Examples of the optical functional member provided opposite to the prism member 11 include an interference fringe prevention layer disclosed in U.S. Pat. No. 5,995,288 (corresponding to Japanese Patent Laid-Open Publication No. 10-300908), a damage prevention layer disclosed in U.S. Patent Application Publication No. 2008/0248256 (corresponding to Published Japanese translation of PCT application No. 2007-529780), a layer for preventing contact damage caused by contact with prism peaks disclosed in U.S. Patent Application Publication No. 2010/0021731 (corresponding to Japanese Patent Laid-Open Publication No. 2010-49243), and a layer for preventing rainbow unevenness. Recently, to reduce the number of parts, it has been considered to remove an upper diffusion film on the prism sheet. The layer for preventing rainbow unevenness, being a diffusion layer, prevents the rainbow unevenness caused by the removal of the upper diffusion film. The layer for preventing rainbow unevenness is a mat layer with haze in the order of 20% to 50%.

Note that the coating liquid is applied on or over the respective surfaces of the base layer 15 to provide the adhesive layers 16 and 55. At least one of the adhesive layers 16 and 55 may have a multilayer structure like the adhesive layer 55 shown in FIG. 2.

In the above embodiments, the prism member 11 is used as the optical functional member. Alternatively, a diffusion member or the like may be used as the optical functional member.

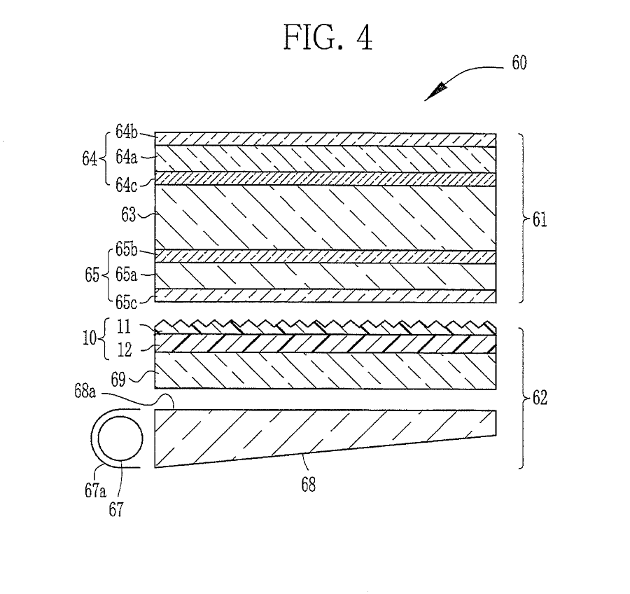

As shown in FIG. 4, an LCD device 60 is provided with an LCD panel 61 and a light source unit 62. The LCD panel 61 controls transmittance and blocking of light, emitted from the light source unit 62, on a pixel-by-pixel basis. The LCD panel 61 has a liquid crystal cell 63 and two polarizing filters 64 and 65. The liquid crystal cell 63 is made up of liquid crystal enclosed between transparent glass substrates. A transparent electrode is formed on an inner face of each of the glass substrates. By applying voltage between the transparent electrodes, a polarizing state of the light passing the liquid crystal cell 63 is changed on the pixel-by-pixel basis. The polarizing filter 64 is provided with a polarizing film 64a and a pair of protection films 64b and 64c affixed to respective surfaces of the polarizing film 64a. The polarizing filters 64 and 65 have the same structure. Namely, the polarizing filter 65 is provided with a polarizing film 65a and protection films 65b and 65c. The polarizing filters 64 and 65 are placed in a crossed Nicols arrangement. The liquid crystal cell 63 is disposed between the polarizing filters 64 and 65.

The light source unit 62 illuminates the LCD panel 61 from the back of the LCD panel 61. The light source unit 62 is provided with a light source lamp 67, a light guide plate 68, a diffusion sheet 69, and the prism sheet 10. The light source lamp 67 is a rod-like fluorescent tube, for example, and placed along an edge of the wedge-shaped light guide plate 68. The illumination light emitted from light source lamp 67 is directly incident on an end of the light guide plate 86 or reflected by a reflector 67a to be incident on the light guide plate 86. The incident illumination light is reflected inside the light guide plate 68 and is exited from an exit surface 68a of the light guide plate 68. The exit surface 68a has substantially the same size as the LCD panel 61.

The diffusion sheet 69 is used for illuminating the whole surface of the LCD panel 61 uniformly. The diffusion sheet 69 is disposed in proximity to the exit surface 68a. The diffusion sheet 69 scatters and diffuses the illumination light, incident from the exit surface 68a, while transmitting the illumination light. Examples of the diffusion sheet 69 include a transparent sheet on which beads-like light diffusion material is dispersed and a sheet in which the light diffusion material is dispersed. To make the light source unit 62 thin, the diffusion sheet 69 and the prism sheet 10 are in close contact with each other and the surface of the diffusion sheet 69 is preferably flat. The flat surface is achieved by, for example, dispersing the light diffusion material inside the diffusion sheet 69, which is employed in this embodiment.

The prism sheet 10 is disposed between the LCD panel 61 and the diffusion sheet 69, and improves the front brightness. In other words, the prism sheet 10 controls distribution of the illumination light so as to increase the amount of the illumination light applied in a normal direction to the LCD panel 61. The size of the prism sheet 10 is substantially the same as the back surface of the LCD panel 61. The illumination light diffused by the diffusion sheet 69 is incident on the prism sheet 10. The illumination light exited from the prism sheet 10 is incident on the LCD panel 61. It is preferable that the prism sheet 10 improves the front brightness by at least 5%.

The following experiments 1 to 12 are performed to verify the effects of the present invention.

### Experiment 1

(Polymerization of polyester)

The dicarboxylic acid units and the diol units (both shown in Table 1) at mole percentages shown in the Table 1 are put in an ester exchanger. Transesterification is performed by increasing temperature to 250° C. in the presence of potassium titanium oxalate under nitrogen atmosphere. Then, the temperature of the exchanger is increased to 225° C. to 260° C. Thereafter, pressure is gradually decreased to 1 mmHg to promote polycondensation reaction. The polyester (25 parts by mass) obtained by the polycondensation reaction is dissolved or dispersed in the distilled water (65 parts by mass) plus a hydrophilic solvent (ethylene glycol mono-t-butyl ether) (10 parts by mass). Thus, aqueous dispersions (PA-1) to (PA-4) of the polyester (A-1) to (A-4) are obtained, respectively. The concentration (solid state content) of the polyester in each of the aqueous dispersions (PA-1) to (PA-4) is 25 mass %.

TABLE 1
Polyester aqueous dispersion

| | Polyester | | | | | | | | | | | | | | | Solid |
|---|---|---|---|---|---|---|---|---|---|---|---|---|---|---|---|---|
| | | Dicarboxylic acid units | | | | | | | | Diol units | | | | | | state |
| | poly- | | mol | | mol | | mol | | mol | | mol | | mol | | mol | content |
| Type | ester | NS | % | NS | % | NS | % | NS | % | NS | % | NS | % | NS | % | (mass %) |
| PA-1 | A-1 | DM2,6-NDC | 56 | — | — | SA | 22 | SD | 22 | EG | 35 | HD | 65 | — | — | 25 |
| PA-2 | A-2 | DM2,6-NDC | 78 | DMT | 10 | — | — | SD | 12 | EG | 100 | — | — | — | — | 25 |
| PA-3 | A-3 | — | — | DMT | 75 | DMI | 15 | SD | 10 | EG | 100 | — | — | — | — | 25 |
| PA-4 | A-4 | — | — | DMT | 27 | DMI | 63 | SD | 10 | EG | 60 | TEG | 30 | DEG | 10 | 25 |

(Abbreviations)
NS: name of substance
DM2,6-NDC: dimethyl 2,6-naphthalene dicarboxylate
DMT: dimethyl terephthalate
SA: sebacic acid
DMI: dimethyl isophthalate
SD: sodium dimethyl 5-sulphonatoisophthalate
EG: ethylene glycol
HD: hexanediol
TEG: triethylene glycol
DEG: diethylene glycol

(Production of Base Layer)

The base layer 15 of the multilayer film 12 was produced by following the steps described below. First, polyethylene terephthalate (hereinafter referred to as PET) with the specific viscosity of 0.64, subjected to polycondensation using Ti compound as a catalyst, was dried to water content of 50 ppm or less. Then, the PET was melted in an extruder at a heater temperature in the range of 280° C. to 300° C. The melted PET was extruded onto a chill roll, to which static electric was applied from a die section, to produce a belt-like amorphous base. The amorphous base was stretched 3.3 times in a lengthwise direction and 3.8 times in a widthwise direction. Thus, the base layer 15 with the thickness of 188 μm was produced.

The base layer 15 was conveyed at a conveying speed of 60 m/min. Each surface of the base layer 15 was subjected to corona discharge treatment of 730 J/m². A coating liquid A was applied on or over each surface of the base layer 15 using a bar coating method. The coating liquid A applied was dried for 1 minute at 145° C. Thereby, the multilayer film 12 having the base layer 15 and the adhesive layers 16 and 55 provided on or over the respective surfaces of the base layer 15 was obtained. The thickness of each of the adhesive layers 16 and 55 was 0.8 μm.

(Coating Liquid A)

Composition of the coating liquid A was as follows.

| Polyester aqueous dispersion (PA-1) | 124.1 | parts by mass |
|---|---|---|
| Polyurethane (polyester-type polyurethane) | 81.6 | parts by mass |
| (SUPERFLEX 150HS available from DAI-ICHI KOGYO SEIYAKU | | |
| CO., LTD., solid content 38%, Tg = 32° C.) | | |
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (aqueous dispersion of MR-2G available from Soken Chemical & | | |
| Engineering Co., Ltd., solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid A to be 1000 parts by mass)

Using the bar coating method with a #10 wire bar having a wire diameter of 250 μm, a coating liquid (prism member coating liquid) for producing the prism member was applied on one of the surfaces of the adhesive layer 16. The prism member coating liquid contained the UV curable resin. The UV light of 450 mJ/cm² (from a metal halide lamp UVL-1500M2 available from USHIO INC.) was applied to the adhesive layer 16 from the base layer 15 side while the mold for forming the prism pattern was pressed against the surface coated with the prism member coating liquid. Thereby, the UV curable resin was cured. Then, the multilayer film 12 was peeled off from the mold. Thus, the prism sheet 10, being the multilayer film 12 having the prism member 11, was obtained. The prism member 11 had a vertical angle of 90°, a pitch of 60 μm, and height of 30 μm. Time between after the application of the prism member coating liquid and before the application of the UV light was 1 minute.

(Coating Liquid for Producing Prism Member)

A composition of the coating liquid for producing the prism member was as follows.

| Bisphenol A diacrylate resin | 23.75 | parts by mass |
|---|---|---|
| (NK Ester A-BPE-10 available from Shin-Nakamura | | |
| Chemical Co., Ltd.) | | |
| Initiator | 1.25 | parts by mass |

(IRGACURE184)

The bisphenol A diacrylate resin used in the experiment 1 is the compound expressed by the general formula (1), and the value of (n+m) is 10.

### Experiment 2

The prism sheet 10 was produced in a manner similar to the experiment 1 except that a coating liquid B is used instead of the coating liquid A. The thickness of each of the adhesive layers 16 and 55 was 1.6 μm.

(Coating Liquid B)

A composition of the coating liquid B was as follows.

| Polyester aqueous dispersion (PA-1) | 248.2 | parts by mass |
|---|---|---|
| Polyurethane (polyester-type polyurethane) | 163.2 | parts by mass |
| (SUPERFLEX 150HS available from DAI-ICHI KOGYO SEIYAKU | | |
| CO., LTD., solid content 38%, Tg = 32° C.) | | |
| Cross-linking agent (oxazoline compound) | 139.8 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 2.0 | parts by mass |
| (aqueous dispersion available from MR-2G Soken Chemical & | | |
| Engineering Co., Ltd., solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid B to be 1000 parts by mass)

### Experiment 3

The prism sheet 10 was produced in a manner similar to the experiment 1 except that a coating liquid C was used instead of the coating liquid A. The thickness of each of the adhesive layers 16 and 55 was 0.8 um.

(Coating Liquid C)

A composition of the coating liquid C was as follows.

| Polyester aqueous dispersion (PA-1) | 173.7 | parts by mass |
|---|---|---|
| Polyurethane (polycarbonate-type polyurethane) | 53.2 | parts by mass |
| (HYDRAN WLS-210 available from DIC Corporation, solid content | | |
| 35%, Tg = −15° C.) | | |
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2HG available from Soken Chemical & Engineering Co., Ltd., | | |
| aqueous dispersion, solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid C to be 1000 parts by mass)

### Experiment 4

The base layer 15 was conveyed at a conveying speed of 60 m/min. Each surface of the base layer 15 was subjected to corona discharge treatment of 730 J/m². A coating liquid D was applied on each surface of the base layer 15 using the bar coating method. The coating liquid D applied was dried for 1 minute at 145° C. Thus, the base adhesion sublayers 51a were provided on the respective surfaces of the base layer 15. Thereafter, a coating liquid E was applied on each base adhesion sublayer 51a using the bar coating method. The coating liquid E applied was dried for 1 minute at 145° C. Thereby, the member adhesion sublayers 51b were provided on the respective surfaces of the base adhesion sublayers 51a. The base adhesion sublayer 51a and the member adhesion sublayer 51b constitute the adhesive layer 51. Thus, the multilayer film 12 having the base layer 15 and the adhesive layers 51 provided on the respective surfaces of the base layer 15 was obtained. The thickness of each adhesive layer 51 was 0.7 μm.

(Coating Liquid D)

A composition of the coating liquid D was as follows.

| Polyester aqueous dispersion (PA-1) | 124.1 | parts by mass |
|---|---|---|
| Cross-linking agent (oxazoline compound) | 36.2 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2G available from Soken Chemical & Engineering Co., Ltd., | | |
| aqueous dispersion, solid content 15%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid D to be 1000 parts by mass)

(Coating Liquid E)

A composition of the coating liquid E was as follows.

| Polyester aqueous dispersion (PA-1) | 62.1 | parts by mass |
|---|---|---|
| Polyurethane (polyester-type polyurethane) | 40.8 | parts by mass |
| (SUPERFLEX 150HS available from DAI-ICHI KOGYO SEIYAKU | | |
| CO., LTD., solid content 38%, Tg = 32° C.) | | |
| Cross-linking agent (oxazoline compound) | 36.2 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid E to be 1000 parts by mass)

### Experiment 5

The prism sheet 10 was produced in a manner similar to the experiment 4 except that each base adhesion sublayer 51a was produced from a coating liquid F instead of the coating liquid D. The thickness of each of the adhesive layers 51 was 0.7 μm.

(Coating Liquid F)

A composition of the coating liquid F was as follows.

| Polyester aqueous dispersion (PA-2) | 124.1 | parts by mass |
|---|---|---|
| Cross-linking agent (carbodiimide compound) | 36.2 | parts by mass |
| (CARBODILITE V-02-L2 available from Nisshinbo Chemical Inc., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2G available from Soken Chemical & Engineering Co., Ltd., | | |
| aqueous dispersion, solid content 15%) | | |
| Preservative | 1.1 | parts by mass |
| (AF-337 available from DAITO CHEMICAL CO., LTD., solid content | | |
| 3.5%, methanol solvent) | | |
| Distilled water | α | parts by mass |

(“α” is adjusted to make the total amount of the coating liquid F to be 1000 parts by mass)

### Experiment 6

The prism sheet 10 was produced in a manner similar to the experiment 4 except that each base adhesion sublayer 51a was produced from a coating liquid G instead of the coating liquid D. The thickness of each adhesive layer 51 was 0.8 μm.

(Coating liquid G)

A composition of the coating liquid G was as follows.

| Polyester aqueous dispersion (PA-2) | 124.1 | parts by mass |
|---|---|---|
| Cross-linking agent (oxazoline compound) | 25.9 | parts by mass |
| (EPOCROS K-2020E available from NIPPON SHOKUBAI CO., LTD., | | |
| solid content 40%) | | |
| Cross-linking agent (carbodiimide compound) | 25.9 | parts by mass |
| (CARBODILITE V-02-L2 available from Nisshinbo Chemical Inc., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2G available from Soken Chemical & Engineering Co., Ltd., | | |
| aqueous dispersion, solid content 15%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid G to be 1000 parts by mass)

### Experiment 7

The prism sheet 10 was produced in a manner similar to the experiment 1 except that a coating liquid H was used instead of the coating liquid A. The thickness of each of the adhesive layers 16 and 55 was 0.7 μm.

(Coating Liquid H)

A composition of the coating liquid H was as follows.

| Polyester aqueous dispersion (PA-1) | 248.2 | parts by mass |
|---|---|---|
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2G available from Soken Chemical & Engineering Co., Ltd., | | |
| aqueous dispersion, solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| 3.5%, methanol solvent) | | |
| Distilled water | α | parts by mass |

(“α” is adjusted to make the total amount of the coating liquid H to be 1000 parts by mass)

### Experiment 8

The prism sheet 10 was produced in a manner similar to the experiment 1 except that a coating liquid I was used instead of the coating liquid A. The thickness of each of the adhesive layers 16 and 55 was 0.8 μm.

(Coating Liquid I)

A composition of the coating liquid I was as follows.

| Polyurethane (polyester-type polyurethane) | 163.2 | parts by mass |
|---|---|---|
| (SUPERFLEX 150HS available from DAI-ICHI KOGYO SEIYAKU | | |
| CO., LTD., solid content 38%, Tg = 32° C.) | | |
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2G available from Soken Chemical & Engineering Co., Ltd., | | |
| aqueous dispersion, solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid I to be 1000 parts by mass)

### Experiment 9

The prism sheet 10 was produced in a manner similar to the experiment 1 except that a coating liquid J was used instead of the coating liquid A. The thickness of each of the adhesive layers 16 and 55 was 0.8 μm.

(Coating Liquid J)

A composition of the coating liquid J was as follows.

| Polyester aqueous dispersion (PA-2) | 173.7 | parts by mass |
|---|---|---|
| Polyurethane (polycarbonate-type polyurethane) | 53.2 | parts by mass |
| (HYDRAN WLS-210 available from DIC Corporation, solid content | | |
| 35%, Tg = −15° C.) | | |
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2HG available from Soken Chemical & Engineering Co., Ltd., | | |
| aqueous dispersion, solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| of 3.5%, methanol solvent) | | |
| Distilled water | α | parts by mass |

(“α” is adjusted to make the total amount of the coating liquid J to be 1000 parts by mass)

### Experiment 10

The prism sheet 10 was produced in a manner similar to the experiment 1 except that a coating liquid K was used instead of the coating liquid A. The thickness of each of the adhesive layers 16 and 55 was 0.8 μm.

(Coating Liquid K)

A composition of the coating liquid K was as follows.

| Polyester aqueous dispersion (PA-3) | 144.8 | parts by mass |
|---|---|---|
| Polyurethane (polycarbonate-type polyurethane) | 53.2 | parts by mass |
| (HYDRAN WLS-210 available from DIC Corporation, solid content | | |
| 35%, Tg = −15° C.) | | |
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2HG available from Soken Chemical & Engineering Co., Ltd., | | |
| aqueous dispersion, solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| 3.5%, methanol solvent) | | |
| Distilled water | α | parts by mass |

(“α” is adjusted to make the total amount of the coating liquid K to be 1000 parts by mass)

### Experiment 11

The prism sheet 10 was produced in a manner similar to the experiment 1 except that a coating liquid L was used instead of the coating liquid A. The thickness of each of the adhesive layers 16 and 55 was 0.8 μm.

(Coating Liquid L)

A composition of the coating liquid L was as follows.

| Polyester aqueous dispersion (PA-4) | 149.7 | parts by mass |
|---|---|---|
| Polyurethane (polycarbonate-type polyurethane) | 53.2 | parts by mass |
| (HYDRAN WLS-210 available from DIC Corporation, solid content | | |
| 35%, Tg = −15° C.) | | |
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2HG available from Soken Chemical & Engineering Co., Ltd., | | |
| aqueous dispersion, solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| 3.5%, methanol solvent) | | |
| Distilled water | α | parts by mass |

(“α” is adjusted to make the total amount of the coating liquid L to be 1000 parts by mass)

### Experiment 12

The prism sheet 10 was produced in a manner similar to the experiment 1 except that a coating liquid M was used instead of the coating liquid A. The thickness of each of the adhesive layers 16 and 55 was 0.8 μm.

(Coating Liquid M)

A composition of the coating liquid M was as follows.

| Polyester aqueous dispersion (PA-1) | 173.7 | parts by mass |
|---|---|---|
| Acrylic resin | 67.7 | parts by mass |
| (EM48D available from DAICEL CORPORATION, solid content | | |
| 27.5%, Tg = 42° C.) | | |
| Cross-linking agent (oxazoline compound) | 69.9 | parts by mass |
| (EPOCROS K-2020E available from NIPPON SHOKUBAI CO., LTD., | | |
| solid content 40%) | | |
| Surface active agent A | 29.7 | parts by mass |
| (1% aqueous solution of NAROACTY CL-95 available from Sanyo | | |
| Chemical Industries, Ltd. ) | | |
| Surface active agent B | 12.3 | parts by mass |
| (1% aqueous solution of RAPISOL B-90 available from NOF | | |
| Corporation) | | |
| PMMA particles | 1.0 | parts by mass |
| (MR-2HG available from Soken Chemical & Engineering Co., Ltd., | | |
| aqueous dispersion, solid content 15%) | | |
| Lubricating agent | 2.9 | parts by mass |
| (carnauba wax dispersion SEROZOL 524 available from Chukyo Yushi | | |
| Co., Ltd., solid content 30%) | | |
| Preservative | 1.1 | parts by mass |
| (AF-337 available from DAITO CHEMICAL CO., LTD., solid content | | |
| 3.5%, methanol solvent) | | |
| Distilled water | α | parts by mass |

(“α” is adjusted to make the total amount of the coating liquid M to be 1000 parts by mass)

### Evaluation

The prism sheets 10 obtained in the respective experiments 1 to 12 were evaluated as follows.

(Evaluation of Adhesive Property Immediately after Production)

Using a single-edge razor, 11 lines were drawn in each of horizontal and vertical directions on the prism member 11 to make 100 squares. Then, an adhesive tape (“600” available from 3M) was affixed to the prism member 11 so as to cover the 100 squares. The tape was completely adhered to the prism member 11 by rubbing the tape with an eraser. Thereafter, the tape was peeled off in a direction 90 degrees to the horizontal plane. Adhesive strength was evaluated (A to E) depending on the number of squares peeled off with the tape.

A: no square was peeled
B: the number of squares peeled off was 1 or more and less than 5.
C: the number of squares peeled off was 5 or more and less than 15
D: the number of squares peeled off was 15 or more and less than 30.
E: the number of squares peeled off was 30 or more
Note that the prism member 11 evaluated “A” or “B” is acceptable as a product.

(Evaluation of Adhesive Property after Thermal Processing)

The prism sheets 10 obtained in the respective experiments 1 to 12 were subjected to thermal processing in which the prism sheets 10 were left at 65° C. and 95% RH for 240 hours. Then, the adhesive property was evaluated. Evaluation criteria were the same as those used for the evaluation of the prism sheets 10 immediately after the production.

(Thickness of Adhesive Layer)

A microtome (RM2255, available from Leica Microsystems) was used to cut a section of the multilayer film 12 before the prism member 11 was formed. The section of the multilayer film 12 was observed using a scanning electron microscope (S-4700 available from HITACHI, Ltd.) to measure the thickness of the adhesive layer 16.

(Haze, Total Light Transmittance)

With the use of a haze meter (NDH-5000 available from NIPPON DENSHOKU INDUSTRIES CO., LTD.), haze and total light transmittance of the multilayer film, formed with the adhesive layers on the respective surfaces, were measured conforming to JIS-K-7105 corresponding to ISO 14782 (haze) and ISO 13468-1 (total light transmittance).

(Prevention of Bleeding Out of Oligomer)

A sample film was cut out from each of the multilayer films 12 obtained in the experiments 1 to 12. The sample films were subjected to thermal processing in which the sample films were left in high temperature environment (at 70° C. and 10% RH) for 24 hours. Increase AH in haze of the sample film between before and after the thermal processing was obtained. The increase AH in haze is represented by an expression below where “Hb” denotes the haze of the sample film before the thermal processing and “Ha” denotes the haze of the sample film after being subjected to the thermal processing.

ΔH=Ha−Hb

The increase AH in haze tends to increase when oligomer bleeds out. Using this fact, the increase LH in haze is evaluated based on the following criteria.

G (good): the increase AH in haze is less than 0.2%

F (fair): the increase AH in haze is 0.2% or more and less than 0.5%

P (poor): the increase AH in haze is 0.5% or more Results of the evaluation are shown in tables 2-1, 2-2, 3-1, and 3-2.

TABLE 2-1

| | Adhesive layer | | | | | | | | | |
|---|---|---|---|---|---|---|---|---|---|---|
| | Polyester | | | Polyurethane | | | Polyacryl | | Cross-linking | |
| | | Tg | | | Tg | | Tg | | agent | |
| | Type | (° C.) | Amt | Type | (° C.) | Amt | (° C.) | Amt | Type | Amt |
| E1 | A-1 | 45 | 0.30 | PP | 32 | 0.30 | — | 0 | OC | 0.27 |
| E2 | A-1 | 45 | 0.60 | PP | 32 | 0.60 | — | 0 | OC | 0.54 |
| E3 | A-1 | 45 | 0.42 | PCP | −15 | 0.18 | — | 0 | OC | 0.27 |
| E7 | A-1 | 45 | 0.60 | — | — | 0 | — | 0 | OC | 0.27 |
| E8 | — | — | 0 | PP | 32 | 0.60 | — | 0 | OC | 0.27 |
| E9 | A-2 | 113 | 0.42 | PCP | −15 | 0.18 | — | 0 | OC | 0.27 |
| E10 | A-3 | 61 | 0.42 | PCP | −15 | 0.18 | — | 0 | OC | 0.27 |
| E11 | A-4 | 30 | 0.42 | PCP | −15 | 0.18 | — | 0 | OC | 0.27 |
| E12 | A-1 | 45 | 0.42 | — | — | 0 | 42 | 0.18 | OC | 0.24 |

Abbreviations
E: Example
Amt: Amount applied per adhesive layer of 1 m² (unit: g/m²)
PP: Polyester-type polyurethane
PCP: Polycarbonate-type polyurethane
OC: Oxazoline compound

TABLE 2-2

| | Result of evaluation | | | | | |
|---|---|---|---|---|---|---|
| | | | Film | Prevention of | | Total light |
| | | | thickness | bleeding out | Haze | transmittance |
| | 1 | 2 | (μm) | of oligomer | (%) | (%) |
| E1 | B | B | 0.8 | G | 1.5 | 91.1 |
| E2 | A | B | 1.6 | G | 2.1 | 91.7 |
| E3 | B | B | 0.8 | G | 1.4 | 91.1 |
| E7 | E | E | 0.7 | G | 1.4 | 90.9 |
| E8 | D | E | 0.8 | P | 1.5 | 91.6 |
| E9 | E | E | 0.8 | G | 1.5 | 91.2 |
| E10 | D | D | 0.8 | F | 1.4 | 91.1 |
| E11 | A | A | 0.8 | P | 1.7 | 91.1 |
| E12 | D | E | 0.8 | G | 1.5 | 91.0 |

Abbreviations
E: Example
1: Adhesive property immediately after production
2: Adhesive property after thermal processing

TABLE 3-1

| | Adhesive layer | | | | | | | | | | | | | |
|---|---|---|---|---|---|---|---|---|---|---|---|---|---|---|
| | Film adhesion sublayer | | | | | | Member adhesion sublayer | | | | | | | |
| | Polyester | | | Poly- | | | Polyester | | | Polyurethane | | | | |
| | | Tg | | urethane | CLA | | | Tg | | | Tg | | CLA | |
| | Type | (° C.) | Amt | Amt | Type | Amt | Type | (° C.) | Amt | Type | (° C.) | Amt | Type | Amt |
| E4 | A-1 | 45 | 0.30 | 0 | OC | 0.14 | A-1 | 45 | 0.15 | PP | 32 | 0.15 | OC | 0.14 |
| E5 | A-2 | 115 | 0.30 | 0 | CC | 0.14 | A-1 | 45 | 0.15 | PP | 32 | 0.15 | OC | 0.14 |
| E6 | A-2 | 115 | 0.30 | 0 | OC + | 0.20 | A-1 | 45 | 0.15 | PP | 32 | 0.15 | OC | 0.14 |
| | | | | | CC | | | | | | | | | |

Abbreviations
E: Example
CLA: Cross-linking agent
Amt: Amount applied per layer of 1 m² (unit: g/m²)
OC: oxazoline compound
CC: carbodiimide compound
PP: polyester-type polyurethane

TABLE 3-2

| | Result of evaluation | | | | | |
|---|---|---|---|---|---|---|
| | | | Prevention of | Film | | Total light |
| | | | bleeding out | thickness | Haze | transmittance |
| | 1 | 2 | of oligomer | (μm) | (%) | (%) |
| E4 | A | B | G | 0.7 | 1.5 | 91.2 |
| E5 | A | A | G | 0.7 | 1.5 | 91.4 |
| E6 | A | A | G | 0.8 | 1.5 | 91.3 |

Abbreviations
E: Example
1: Adhesive property immediately after production
2: Adhesive property after thermal processing

Various changes and modifications are possible in the present invention and may be understood to be within the present invention.

What is claimed is:

1. A multilayer film for supporting an optical functional member, comprising:
a polyester layer; and
an adhesive layer to be adhered to the optical functional member, the adhesive layer being provided on at least one of surfaces of the polyester layer, the adhesive layer containing polyester for the adhesive layer, polyurethane, and a cross-linking agent, a glass transition temperature Tg of the polyester for the adhesive layer being less than 60° C., at least 30 mol % of dicarboxylic acid units in the polyester for the adhesive layer having naphthalene rings.

2. The multilayer film of claim 1, wherein the adhesive layer has a base adhesion sublayer provided on the polyester layer and a member adhesion sublayer provided on the base adhesion sublayer, and the base adhesion sublayer contains polyester for the base adhesion sublayer, and at least 30 mol % of dicarboxylic acid units in the polyester for the base adhesion sublayer have naphthalene rings, and the member adhesion sublayer contains the polyester for the adhesive layer, the polyurethane, and the cross-linking agent, and the member adhesion sublayer has an adhesive surface to be adhered to the optical functional member, and mass concentration of the polyester for the base adhesion sublayer is higher than mass concentration of the polyester for the adhesive layer contained in the member adhesion sublayer.

3. The multilayer film of claim 2, wherein a glass transition temperature Tg of the polyester for the base adhesion sublayer is higher than a storage temperature of the multilayer film.

4. The multilayer film of claim 3, wherein the glass transition temperature Tg of the polyester for the base adhesion sublayer is higher than the glass transition temperature Tg of the polyester for the adhesive layer contained in the member adhesion sublayer.

5. The multilayer film of claim 1, wherein thickness of the adhesive layer is in a range of at least 0.5 μm and at most 2.5 μm.

6. A prism sheet comprising:
a polyester layer; and
an adhesive layer provided on at least one of surfaces of the polyester layer, the adhesive layer containing polyester, polyurethane, and a cross-linking agent, a glass transition temperature Tg of the polyester being less than 60° C., at least 30 mol % of dicarboxylic acid units in the polyester having naphthalene rings; and
a prism member adhered to the adhesive layer and made from solvent-free UV-cured acrylic resin, the prism member being an optical functional member, the optical functional member being supported by a multilayer film, the multilayer film including the polyester layer and the adhesive layer.

7. The prism sheet of claim 6, wherein at least 40 mass % of the solvent-free UV-cured acrylic resin is composed of resin components each expressed by a general formula (1) and having an average added mol number (n+m), of polyethylene oxide chain, of at least 5.

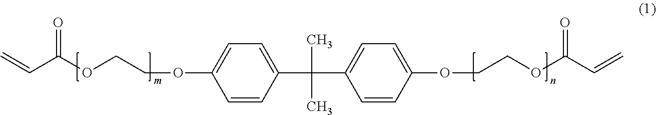

8. A method for producing a multilayer film for supporting an optical functional member, the multilayer film including a polyester layer, the method comprising the steps of:
applying an adhesive layer coating liquid over the polyester layer to form a coating layer covering the polyester layer, the adhesive layer coating liquid containing polyester for an adhesive layer, polyurethane, a cross-linking agent, and a solvent, the polyester for the adhesive layer having a glass transition temperature Tg of less than 60° C., at least 30 mol % of dicarboxylic acid units in the polyester for the adhesive layer having naphthalene rings; and
evaporating the solvent from the coating layer to form the adhesive layer to be adhered to the optical functional member.

9. The method of claim 8, further comprising the steps of:
applying a base adhesion sublayer coating liquid on the polyester layer to form a base adhesion sublayer coating layer, the base adhesion sublayer coating liquid containing polyester for a base adhesion sublayer, a cross-linking agent, and a solvent, at least 30 mol % of dicarboxylic acid units in the polyester for the base adhesion sublayer having naphthalene rings;
evaporating the solvent from the base adhesion sublayer coating layer to form the base adhesion sublayer, mass concentration of the polyester for the base adhesion sublayer in a solid content of the base adhesion sublayer coating liquid being higher than mass concentration of the polyester for the adhesive layer in a solid content of the adhesive layer coating liquid, the adhesive layer coating liquid being applied on the base adhesion sublayer.
